(19) United States
(12) Patent Application Publication
(10) Pub. No.: US 2012/0134582 A1
(43) Pub. Date: May 31, 2012

(54) System and Method for Multimodal Detection of Unknown Substances Including Explosives

(75) Inventors: Patrick Treado, Pittsburgh, PA (US); Robert Schewitzer, Pittsburgh, PA (US); Jason Neiss, Pittsburgh, PA (US)

(73) Assignee: ChemImage Corporation, Pittsburgh, PA (US)

(21) Appl. No.: 13/193,860

(22) Filed: Jul. 29, 2011

Related U.S. Application Data
(63) Continuation-in-part of application No. 12/718,362, filed on Mar. 5, 2010, now Pat. No. 7,990,532.
Application No. 12/718,362 is a continuation of application No. 11/632,471, filed on Jan. 16, 2007, now Pat. No. 7,679,740.

(51) Int. Cl. G06K 9/00

(52) U.S. Cl. 382/165

(57) ABSTRACT

A system and method for identifying an unknown substance in a sample comprising multiple entities. A method may comprise generating a RGB image representative of a sample and assessing said RGB image to identify at least one region of interest. This region of interest may he assessed to generate a spatially accurate wavelength resolved image, which may be a hyperspectral image. This spatially accurate wavelength resolved image may comprise a fluorescence, Raman, near infrared, short wave infrared, mid wave infrared and/or long wave infrared image. This spatially accurate wavelength resolved image may be assessed to identify said unknown substance. A system may comprise: a reference database, a first detector for generating an RGB image, a second detector for generating a spatially accurate wavelength resolved image, and a means for assessing said RGB image and said spatially accurate wavelength resolved image.

### RELATED APPLICATIONS

This Application is a continuation-in-part of pending U.S. patent application Ser. No. 12/718,362, entitled “Method And Apparatus For Multimodal Detection,” filed on Mar. 5, 2010, which itself is a continuation of U.S. Pat. No. 7,679,740, entitled “Method And Apparatus For Multimodal Detection,” filed on Jan. 16, 2007. U.S. Pat. No. 7,679,740 is a National Stage entry of PCT/US05/25112, filed on Jul. 14, 2005, entitled “Method And Apparatus For Multimodal Detection”, and claims priority under 35 U.S.C. §119(e) to U.S. Provisional Patent Application No. 60/588,212, filed on Jul. 15, 2004, entitled “Algorithm For Detecting Pathogenic Microorganisms Via Chemical Imaging”. These patents and patent applications are hereby incorporated by reference in their entireties.

### BACKGROUND

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination sage gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the entire area encompassing the sample simultaneously using an electronically tunable optical imaging filter such as an acousto-optic tunable filter (“AOTF”) or a LCTF. This may be referred to as “wide-field imaging”. Here, the organic material in such optical filters are actively aligned by applied voltages to produce the desired bandpass and transmission function. The spectra obtained for each pixel of such an image thereby forms a complex data set referred to as a hyperspectral image (“HSI”) which contains the intensity values at numerous wavelengths or the wavelength dependence of each pixel element in this image.

Spectroscopic devices operate over a range of wavelengths due to the operation ranges of the detectors or tunable filters possible. This enables analysis in the Ultraviolet (“UV”), visible (“VIS”), Raman, near infrared (“NIR”), short-wave infrared (“SWIR”), mid infrared (“MIR”) wavelengths and to some overlapping ranges. These correspond to wavelengths of about 180-380 nm (UV), 380-700 nm (VIS), 700-2500 nm (NIR), 900-1700 nm (SWIR), and 2500-25000 nm (MIR).

It is becoming increasingly important and urgent to rapidly and accurately identify hazardous agents such as pathogens, toxic materials, and explosives with a high degree of reliability, particularly when the unknown substance may be purposefully or inadvertently mixed with other materials. In uncontrolled environments, such as the atmosphere, a wide variety of airborne organic particles from humans, plants and animals occur naturally. Many of these naturally occurring organic particles appear similar to some toxins and pathogens even at a genetic level. It is important to be able to distinguish between these organic particles and the toxins/pathogens.

In cases where hazardous agents are purposely used to inflict harm or damage, they are typically mixed with so-called “masking agents” to conceal their identity. These masking agents are used to trick various detection methods and systems to overlook or be unable to distinguish the substance mixed therewith. This is a recurring concern for homeland security where the malicious use of hazardous agents may disrupt the nation's air, water and/or food supplies. Additionally, certain businesses and industries could also benefit from the rapid and accurate identification of the components of mixtures and materials. One such industry that comes to mind is the drug manufacturing industry, where the identification of mixture composition could aid in preventing the alteration of prescription and non-prescription drugs. This may also be of particular concern for detecting explosive materials and residues and chemical threat agents.

One known method for identifying an unknown substance contained within a mixture is to measure the absorbance, transmission, reflectance or emission of each component of the given mixture as a function of the wavelength or frequency of the illuminating or scattered light transmitted through the mixture. This, of course, requires that the mixture be separable into its component parts. Such measurements as a function of wavelength or frequency produce a signal that is generally referred to as a spectrum. The spectra of the components of a given mixture, material or object, i.e., a sample spectra, can be identified by comparing the sample spectra to set a reference spectra that have been individually collected for a set of known elements or materials. The set of reference spectra are typically referred to as a spectral library, and the process of comparing the sample spectra to the spectral library is generally termed a spectral library search. Spectral library searches have been described in the literature for many years, and are widely used today. Spectral library searches using infrared (approximately 750 nm to 100 nm wavelength), Raman, fluorescence or near infrared (approximately 750 nm to 2500 nm wavelength) transmissions are well suited to identify many materials due to the rich set of detailed features these spectroscopy techniques generally produce. The above-identified spectroscopic techniques produce rich fingerprints of the various pure entities, which can be used to identify the component materials of mixtures via spectral library searching.

Conventional library searches generally cannot even determine the composition of mixtures—they may be used if the user has a pure target spectrum (of a pure unknown) and would like to search against the library to identify the unknown compound. Further, library searches have been found to be inefficient and often inaccurate. Where time is of the essence searching a component library can be exceedingly time consuming and if the sample under study is not a pure component, a search of pure component library will be futile. Therefore, there exist a need for accurate and reliable identification of unknown substances that may be hazardous materials.

### SUMMARY OF THE INVENTION

The present disclosure provides for a system and method for assessing a sample using spectroscopic and chemical imaging techniques, including hyperspectral imaging. More specifically, the present disclosure provides for the use of ROB imaging to target an area of interest of a sample. This area of interest may then be further interrogated using one or more chemical imaging techniques to identify an unknown substance in the sample. Chemical imaging techniques that may be applied may include Raman, fluorescence, and infrared chemical imaging. The present disclosure contemplates that near infrared, short wave infrared, mid wave infrared, and/or long wave infrared chemical imaging may be applied. The system and method provided for herein overcome the limitations of the prior art, holding potential for accurate and reliable identification of unknown substances in samples comprising multiple entities,

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

FIG. 1 is an exemplary detection diagram according to one embodiment of the disclosure;

FIG. 2 provides an exemplary algorithm for targeting a region of interest likely to provide a quality test spectrum;

FIG. 3 is an exemplary algorithm for computing the distance represented by a sample from each known class in the library;

FIG. 4 is an exemplary algorithm for spectral unmixing;

FIG. 5 shows a method for determining eigenvectors from reference spectra according to one embodiment of the disclosure;

FIG. 6A shows an exemplary method for creating class models from the reference spectra and eigenvectors;

FIG. 6B shows a principal component scatter plot for the model of FIG. 6A; and

FIG. 7 schematically shows a method for mapping an unknown spectrum to PC space according to one embodiment of the disclosure.

FIG. 8 is illustrative of a method of the present disclosure.

### DETAILED DESCRIPTION

The instant disclosure relates to a system and method for implementing multi-modal detection. More specifically, the disclosure relates to a system and method configured to examine and identify an unknown substance. The unknown substance may include but is not limited to: a biological substance, a chemical substance, an explosive substance, a toxic substance, a hazardous substance, an inert substance in a physical mixture, and combinations thereof.

A system according to one embodiment of the disclosure may include one or more detection probes or sensors in communication with an illumination source and a controller mechanism. The sensors can be devised to receive spectral and other attributes of the sample and communicate said information to the controller. The controller may include one or more processors in communication with a database for storing spectral library or other pertinent information for known samples. The processor can be programmed with various detection algorithms defining instructions for identification of the unknown sample.

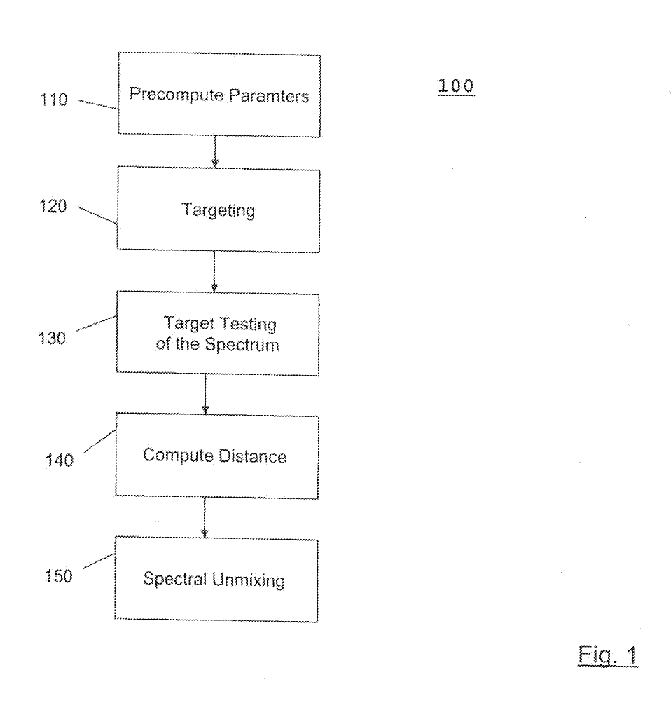

FIG. 1 is an exemplary detection algorithm according to one embodiment of the disclosure. Flow diagram 100 defines an algorithm for implementing a series of instructions on a processor. In step 110, the detection algorithm 100 defines pre-computation parameters stored in a library. In any detection or classification application, the more a priori information available about the desired targets and undesired backgrounds and interference, the better the expected detection probability. The pre-computation parameters may include assembling a library of known samples. The library may include, for example, a spectral library or a training set. In one embodiment, the library includes entire optical, UV, RGB, infrared, and/or Raman images of known substances and biological material. If the algorithm is configured for a multimodal device, step 110 may also include defining additional parameters such as shape, size, color or the application of pattern recognition software. If one of the contemplated modes is UV fluorescence, then step 110 may include storing fluorescence spectra directed to identifying the UV signature of known substances including biological substances. If one of the contemplated modes is Raman imaging, then step 110 may further include storing Raman parameters (i.e., spectra) of various known substances.

To address this issue, in one embodiment the disclosure relates to reducing complex datasets to a more manageable dataset by instituting principal component analysis (“PCA”) techniques. The PCA analysis allows storing the most pertinent (alternatively, a reduced number of data points) in the library. Stated differently, PCA can be used to extract features of the data that may contribute most to variability. By storing PCA eigenvectors tractable storage of class variability can substantially reduce the volume of stored data in the library. While the PCA eigenvectors are not identifiers per se, they allow tractable storage of class variability. They are also a key component of subspace-based detectors. Moreover, the information in the library is dependent on the type of classifier used. A classifier, can be any arbitrary parameter that defines one or more attribute of the stored data. For example, the Mahalanobis classifier requires the average reduced spectrum and covariance matrix for each type of material, or class, in the library. In one embodiment, a class can be an a priori assignment of a type of known material. For example, using an independently validated sample of material, one can acquire spectral data and identify the data as belonging to material from that sample. Taking multiple spectra from multiple samples from such a source, one can create a class of data for the classification problem.

As stated, the multimodal library can store training data. The training algorithm typically includes pure component material data and instructions for extracting applicable features therefrom. The applicable features may include: optical imaging, morphological features (i.e., shape, color, diameter, area, perimeter), UV fluorescence (including full spectral signatures), Raman dispersive spectroscopy and Raman imaging (including full spectral signatures). Using PCA techniques in conjunction with the training algorithm, the data can be reduced to eigenvectors to describe the variability inherent within the material and represent reduced dimensional subspaces for later detection and identification.

Thus, according to one embodiment, step 110 includes: (a) defining the overall PCA space; (b) defining the so-called confusion areas; (c) defining classes and subclasses in the same PCA space (compute model parameters); (d) defining sub-spectral bands (e.g., CH-bands and other common fingerprints); (e) computing threat morphological features.

Once a sample is selected for testing, the first step is to narrow the field of view (“FOV”) of the detection probe to the sub-regions of the sample containing the most pertinent information. The sub-regions may include portions of the sample containing toxic chemical or adverse biological material. To this end, step 120 of FIG. 1 is labeled targeting. In bio-threat identification applications time is of the essence. The FOV and the time to identify are related to the spectral signal to noise ratio (“SNR”) achievable. Higher SNR can be obtained from interrogating regions containing high amounts of suspect materials, so total acquisition time is reduced by carefully determining specific interrogation regions.

In one embodiment, the disclosure relates to identifying those candidate regions using rapid sensors. The FOV selection of specific candidate regions defines targeting. In one embodiment, targeting is reduced to a multi-tiered approach whereby each tier eliminates objects that do not exhibit properties of the target. For example, targeting may include optical imaging and UV fluorescence aging. In optical imaging, the sample is inspected for identifying target substances having particular morphology features. In UV fluorescence imaging, the target may be a biological material that fluoresces once illuminated with the appropriate radiation source. If multiple sensors are used, each sensor can be configured for a specific detection. If on the other hand, a multi-mode single sensor is used, each sensor modality can have characteristics that lend itself to either targeting or identification.

The optical imaging mode can recognize potential threat material via morphological features while UV Fluorescence imaging is sensitive to biological material. Combining the results of the two modes can result in identifying locations containing biological material that exhibits morphological properties of bio-threat or hazardous agents.

In step 130 of FIG. 1, the algorithm calls for targeting the sample. In this step the FOV is narrowed to one ore more target regions and each region is examined to identify its composition. In one embodiment, the testing step may include Raman acquisition. The Raman acquisition algorithm can be configured to operate with minimal operator input. Eventual bio-threat detection systems can be fully automated to ensure that the test spectrum is suitable for the detection process. Because detection probability depends highly on the test spectrum's signal-to-noise ratio “SNR”), the system can be programmed to ignore any spectra falling below a pre-defined threshold. In one exemplary embodiment, SNR of about 20 is required for accurate detection. The SNR determination can be based on examining the signal response in CH-regions as compared to a Raman-empty (i.e., noise-only) region. If the target spectrum readily matches that of a known substance, then the target identification task is complete and the system can generate a report. If on the other hand, the target spectrum is not defined by the pre-computed parameters, then it can be mapped into PCA space for dimension reduction and outlier detection (see step 140 in FIG. 1). Outlier detection involves determining if the spectrum is significantly different from all classes to indicate a possible poor acquisition or the presence of an unknown material.

Conventional detection and classification methods address the problem of identifying targets when background noise and other interferences are paramount. Such methods include, for example, linear discriminate analysis (LDA), adaptive matched filter classifiers (AMF), adaptive matched subspace detectors (AMSD) and orthogonal subspace (OSP) projection derived classifiers,

According to one embodiment of the disclosure a heuristic method is used to identify and to compare the dispersive test spectrum with each candidate class and choose the class closest to the test spectrum by measuring the minimum distance measured with a known metric. One such computational metric is derived from Euclidean geometry. The Euclidean distance (or minimum Euclidean distance) compares two vectors of length n by:

$${d}_{E} = \vert x - y \vert = {( {\sum }_{i = 1}^{n} {\vert {x}_{i} - {y}_{i} \vert}^{2} )}^{1 / 2} \qquad ( 1 )$$

In the stated embodiment, x and y are two full-length spectral vectors.

In accordance with one embodiment of the disclosure, the distance d.sub.E is calculated for the test spectrum against the average spectrum of each training classes along with each spectrum in a comprehensive spectral library comprised of a single spectrum per class (see step 110). If the minimum Euclidean distance (d.sub.E) results in a unique match that is one of the full training classes, it may be reported as the identity of the sample. On the other hand, if the minimum Euclidean distance does not match one of the training classes, the Mahalanobis distance can be used next to further identify the sample. The Mahalanobis metric can be viewed as an extension of Euclidean distance which considers both the mean spectrum of a class and the shape, or dispersion of each class. The dispersion information is captured in the covariance matrix C and the distance value can be calculated as follows:

d_{M}[(x−y)^{T}·C·(x−y)]^{1/2}

An advantage of estimating the Mahalanobis distance, d.sub.M, is that it accounts for correlation between different features and generates curved or elliptical boundaries between classes. In contrast, the Euclidean distance, d.sub.E, only provides spherical boundaries that may not accurately describe the data-space. In equation (2), C is the covariance matrix that is defined for each class from the eigenvector PCA value. Thus, according to one embodiment of the disclosure, the training library defines a set of mean vectors and covariance matrices derived from the PCA eigenvectors of each class. In addition to checking for minimum distance, one embodiment the disclosure determines whether the test spectrum lies in the so-called confusion region of overlapping classes. The mean vector and covariance matrix define a hyper-ellipse with dimensions equal to the number of eigenvectors stored for each model. When projected onto two dimensions for visualization, ellipses can be drawn around the 2-.sigma. confidence interval about the mean for each class. If the test spectrum (represented by a point in the principal component space (PC space) lies within the 2-.sigma. interval (for each projection) it is likely a member of that class. Thus, the overlap regions can be clearly seen, and if a test spectrum is a member of more than one class, the spectrum is likely a mixture of more than one component. In one embodiment of the disclosure an imaging channel and a spectral unmixing algorithms are used to identify the contents of the mixture.

The specified spectral unmixing algorithm is capable of determining the constituents of a mixed spectrum and their level of purity or abundance. Thus, when a unique class is not determined from a dispersive spectrum through Mahalanobis distance calculation, spectral unmixing can be used. An exemplary unmixing algorithm is disclosed in PCT Application No. PCT/US2005/013036 filed Apr. 15, 2005 by the assignee of the instant application, the specification of which is incorporated herein in its entirety for background information.

If neither Raman imaging nor spectral unmixing is capable of identifying the sample's spectrum, or if the spectrum represents an outlier from the library classes, the decomposition method of Ramanomics can be implemented. Ramanomics defines a spectrum according to its biochemical composition. More specifically, Ramanomics determines whether the composition is composed of proteins, lipids or carbohydrates and the percent of each component in the composition. According to one embodiment, the constituent amounts are estimated by comparing the input spectrum to spectra from each of the constituents.

In step 150 a report is generated to identify the sample's composition. Depending on the analysis technique, different results can be reported. The results may include a unique class, a list of overlapping classes, a pure non-library class or the presence of an outlier component. If a unique class is identified, the results may include a corresponding confidence interval obtained based on Euclidean or Mahalanobis distance values.

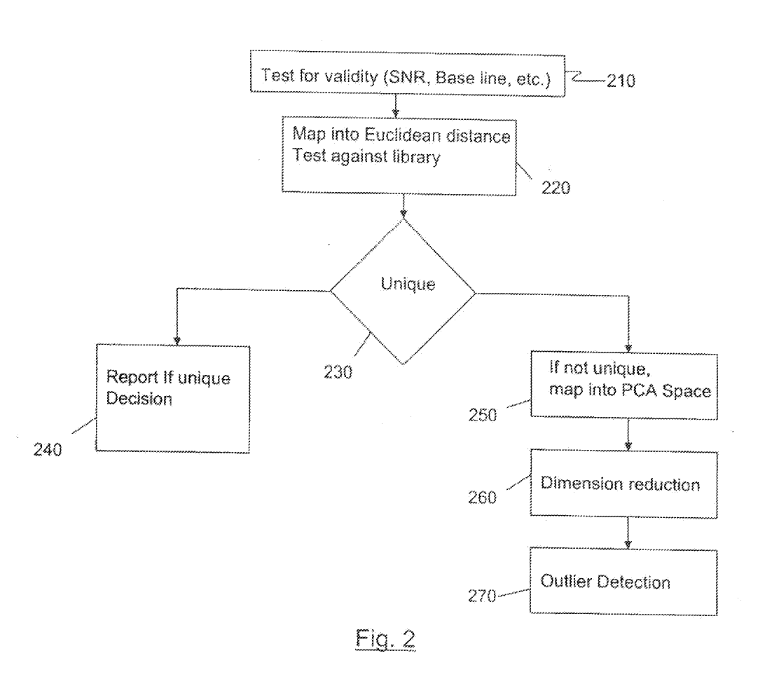

FIG. 2 provides an exemplary algorithm for target testing of the spectrum. In step 210 of FIG. 2 a test is conducted to assess validity of the spectrum. As stated, this can be accomplished by comparing the sample's spectrum against a pre-defined threshold or baseline. In step 220, the sample's spectra is mapped into the Euclidean space. This can be done, for example by determining d.sub.E according to equation (I). Once mapped into the Euclidean space, the distance can be tested against library classes not defined by pre-compute parameters (see step 110, FIG. 1). If the distance d.sub.E is not defined by the library of parameter, then the sample under test can represent a unique material. Should this be the case, the result can be reported as shown in step 240. If the d.sub.E does not represent a unique material (step 230) then its spectra can be mapped into PCA space (step 250) for dimension reduction (step 260) and for outlier detection (step 270). Dimension reduction can be accomplished through conventional PCA techniques.

If the sample is determined to be an outlier, then its spectra can be saved for review. Alternatively, Ramanomics can be used to further determine whether the sample is a mixture. If the sample is not a mixture then it can be identified as a new class of material.

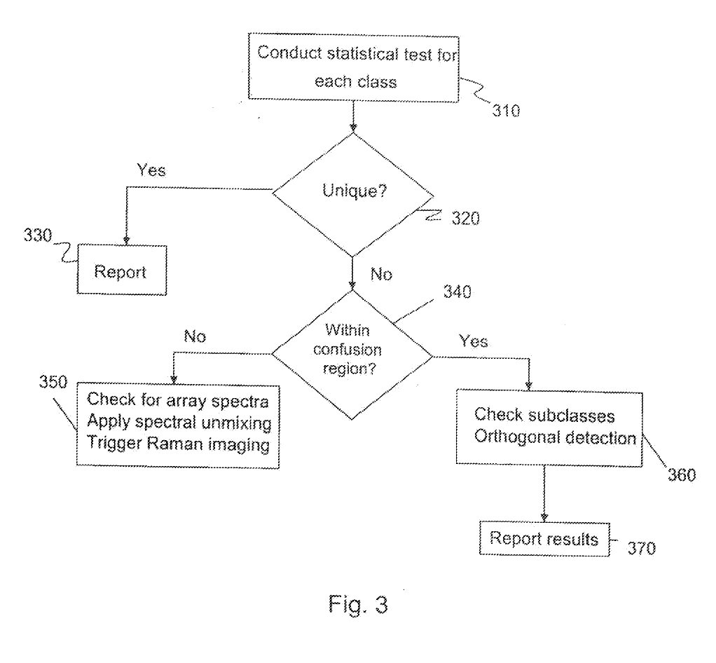

FIG. 3 is an exemplary algorithm for computing the distance represented by a sample from each known class in the library. In step 310 a statistical test is performed for each class of material identified within the sample. The statistical test may determine whether the material is a unique material (see step 320). If the material is unique, then it can be reported immediately according to step 320. If the statistical test shows that the material is not unique, then it must be determined whether the sample result is within the confusion region (step 340). The statistical test can be Euclidean Distance, Mahalanobis Distance, or other similar distance metrics. Subspace detection methods use hypothesis testing and generalized likelihood tests to assess similarity,

If it is determined that the material is within the confusion region, the various subclasses, stored in the library, are assessed to determine whether the sample belongs to any such subclass. To this end, a method of orthogonal detection can be implemented to determine whether the sample matches any such subclass. According to one embodiment of the disclosure, the orthogonal detection consists of performing wide-field Raman imaging on the region to derive a spectral signature for each pixel in a spectral image. These spatially-localized spectra are then classified individually to produce a classified Raman image.

If the material is within a confusion region (step 350), then one or more of the following steps can be implemented: (1) check the fiber array spectra; (2) apply spectral unmixing; (3) conduct orthogonal detection and Raman imaging of the sample; and (4) save the results for review. In implementing the step of checking the fiber array spectra the dispersive Raman detector produces an average signal taken over a spatial FOV by combining signals from a set of optical fibers. By examining the individual fibers and their corresponding signals, one embodiment of the disclosure obtains more local spectral estimates from points within the FOV. These local spectra are more likely to be pure component estimates than the overall average dispersive spectrum.

The step of conducting Raman imaging can be implemented because dispersive spectroscopy integrates the Raman signal over an entire FOV. Thus, if more than one material occupies the FOV, the spectrum will be a mixture of all those components. One solution is to increase the spatial resolution of the sensor. According to this embodiment, wide-field Raman imaging system is employed. If a suspected target arises from the dispersive analysis, Raman imaging can isolate the target component. In this manner, Mahalanobis distance test can be performed on each spectrum in the Raman image.

If the sample is determined to be outside of all classes (not shown in FIG. 3), then the algorithm can check the fiber array spectra (or nominal mixture spectra) to determine whether the sample defines a mixture. If so, a spectral unmixing algorithm can be implemented to determine its components and their amounts. Further orthogonal detection can also be implemented at this stage through Raman aging to further the analysis. In step 370, the results are reported to the operator.

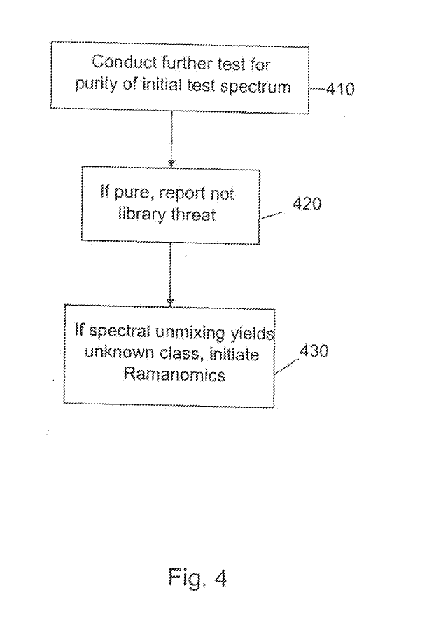

In the event that the above algorithms are unable to determine the sample's composition, spectral unmixing can be implemented. FIG. 4 is an exemplary algorithm for spectral unmixing if Mahalanobis sequence fails to identify the sample's composition. Assuming that the spectral unmixing is unsuccessful, step 410 of FIG. 4 calls for further testing to determine the purity of the initial test spectrum. Purity assessment involves examining the intermediate results from spectral unmixing to assess the correlation of the spectrum with all the library entries and combinations of library entries.

If it is determined that the initial test spectrum defines a pure sample, then it will be reported that the material under study does not pose a threat and a Ramanomics algorithm is initiated. In addition, if the spectral unmixing yields unknown class, Ramanomics algorithm is also initiated to determine the relative similarity of the test spectrum to biological compounds.

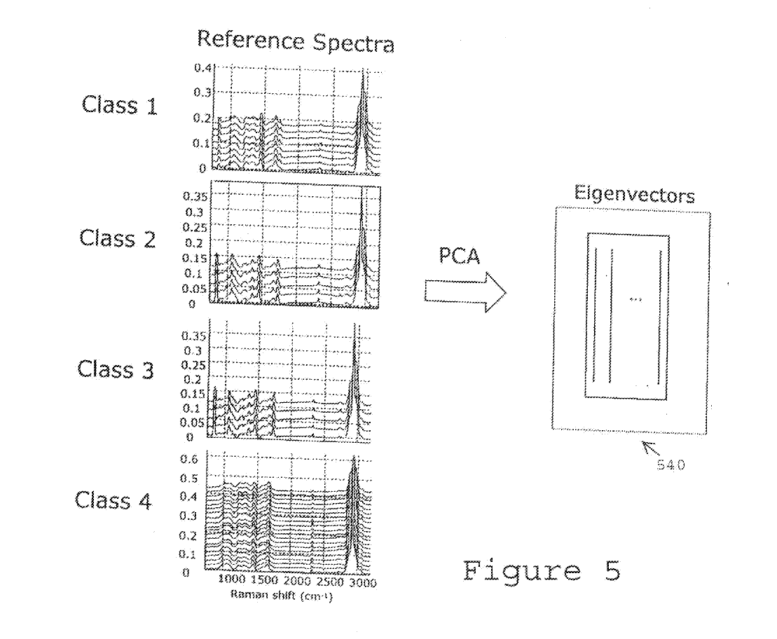

An exemplary application of the method and system according to one embodiment of the disclosure is shown in FIGS. 5-7. Specifically, FIG. 5 shows a method for determining eigenvectors according to one embodiment of the disclosure. Referring to FIG. 5, several reference spectrum are shown as class 1 through class 4. Each class defines a unique spectra which is the fingerprint of the material it represents. Using the principal component analysis, classes 1-4 can be represented as eigenvectors, schematically shown as matrix 540. This information can be stored in the library as discussed in reference to step 110 of FIG. 1.

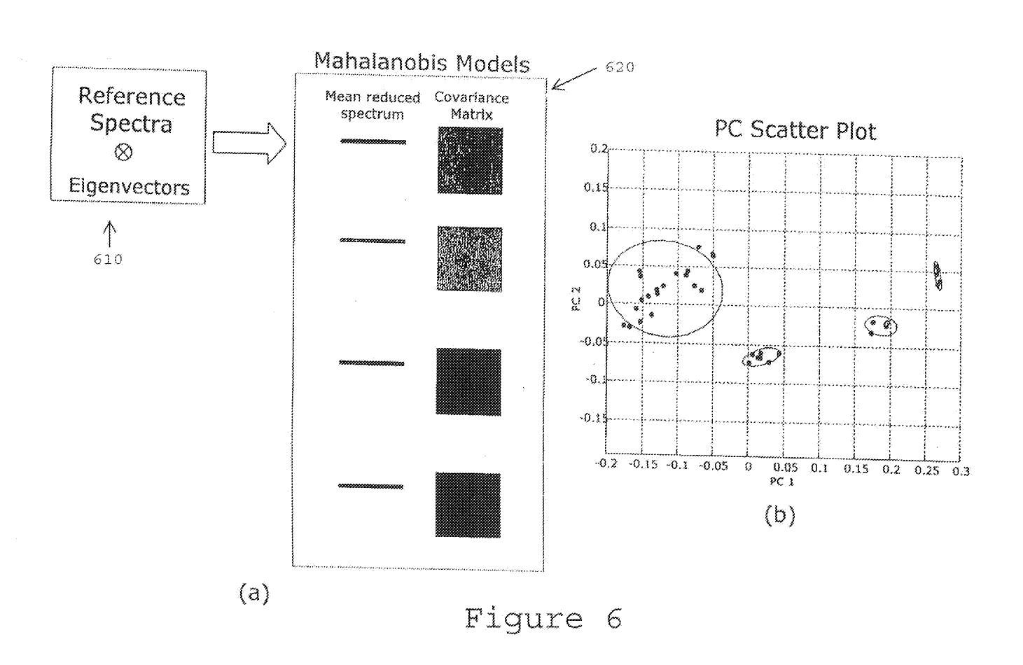

FIG. 6A shows an exemplary method for creating class models from the reference spectra and eigenvectors. In step 610, the reference spectra are multiplied by the eigenvectors to transform the spectra into a form suitable for inclusion as Mahalanobis models 620.

FIG. 6B shows a principal component scatter plot for the model of FIG. 6A. In the scatter plot each dot represents a spectrum in PC space. Here, principal component 1 (PC1) is plotted on the X-axis, and principal component 2 (PC2) is plotted on the Y-axis. For these classes, PC1 captures the most of the variability among the spectra, as seen by the separation of the classes in the PC1 dimension. The ellipses around the classes represent the 2-.sigma. intervals accounting for approximately 95% of the likelihood of class membership.

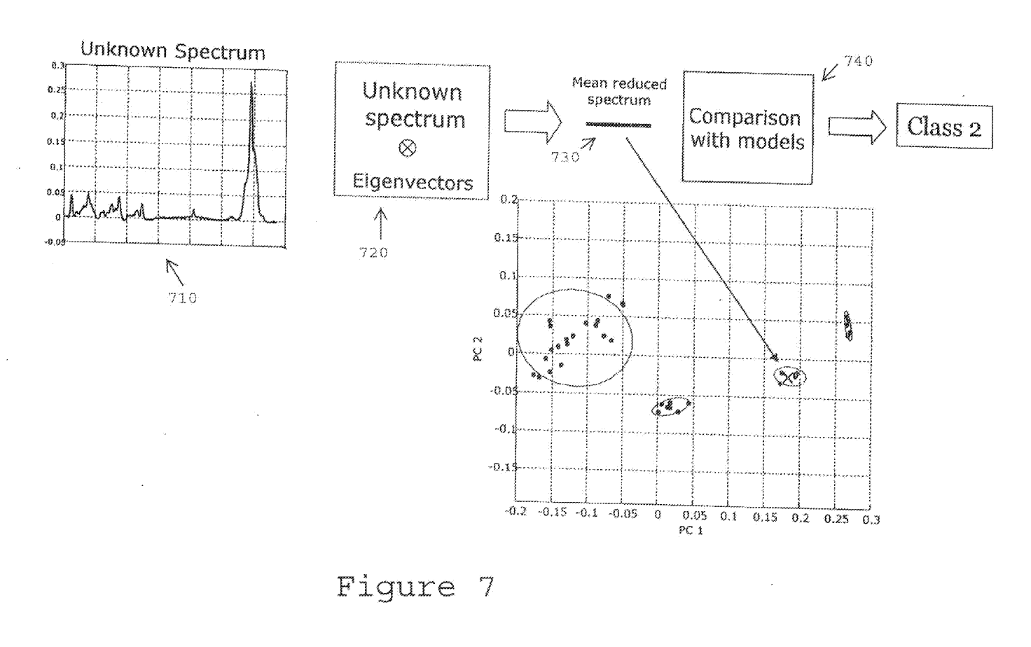

FIG. 7 schematically shows a method for mapping an unknown spectrum to PC space according to one embodiment of the disclosure. In FIG. 7, an unknown sample's spectrum is shown as spectrum 710. The unknown spectrum is reduced to eigenvectors in step 720 and a mean reduced spectrum 730 is obtained therefrom. In step 740, the mean reduced spectrum is compared with models existing in the library by mapping the known mean reduced spectrum into PC space. Depending on the location of the known mean reduced spectrum in the PC space and its proximity to the closest known class, the unknown sample can be identified. FIG. 7 illustrates this concept.

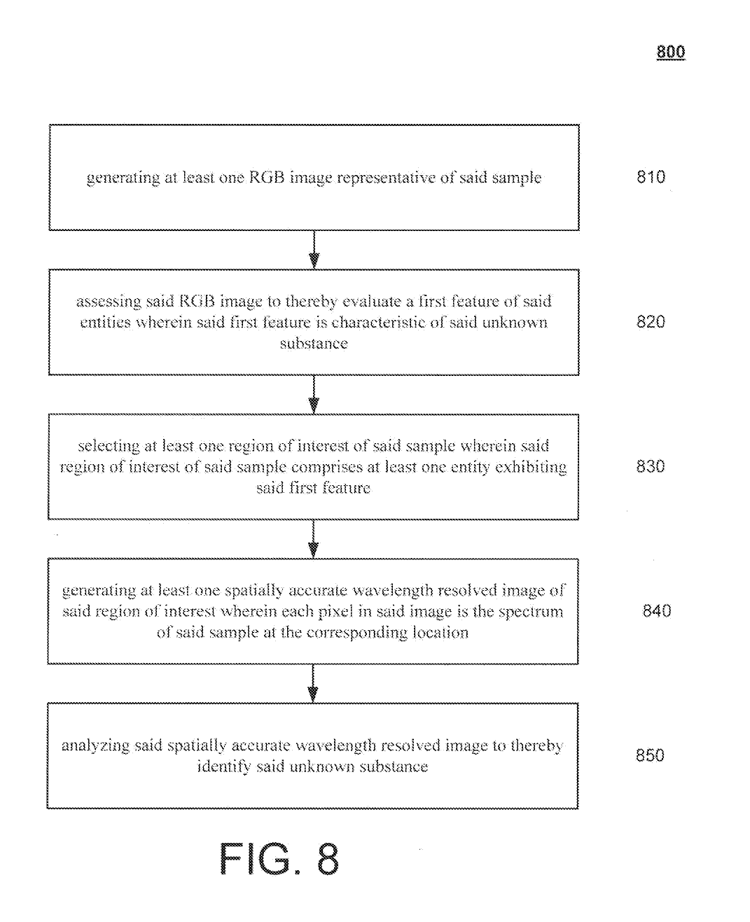

In another embodiment, illustrated by FIG. 8, the present disclosure provides for a method for assessing the occurrence of an unknown substance in a sample that comprises multiple entities. The method 800 may comprise generating at least one RGB image representative of said sample in step 810. In one embodiment, assessing of said RGB image may further comprise assessing at least one morphological feature. This morphological feature may be selected from the group consisting of: shape, color, size, and combinations thereof. In one embodiment, this assessment may be achieved by visual inspection by a user. In another embodiment, this assessment may be achieved by comparing the RGB image to at least one reference data set in a reference database, each reference data set corresponding to a known substance. In yet another embodiment, this assessment may be achieved by a combination of visual inspection and comparison to a reference data set.

In step 820, this RGB image may be assessed to thereby evaluate a first feature of said entities herein said first feature is characteristic of said unknown substance. In step 830, at least one region of interest of said sample may be selected wherein said region of interest of said sample comprises at least one entity exhibiting said first feature.

At least one spatially accurate wavelength resolved image of said region of interest may be generated in step 840. In one embodiment, this spatially accurate wavelength resolved image may comprise a hyperspectral image. In one embodiment, generating this spatially accurate wavelength resolved image may further comprise: collecting a first plurality of interacted photons representative of said region of interest, wherein said first plurality of interacted photons are selected from the group consisting of: photons absorbed by said region of interest, photons reflected by said region of interest, photons emitted by said region of interest, photons scattered by said region of interest, and combinations thereof; passing said first plurality of interacted photons through a filter; and detecting said first plurality of interacted photons to thereby generate said spatially accurate wavelength resolved image.

In one embodiment, this first plurality of interacted photons may be generated by illuminating said region of interest. This illuminating may be accomplished using active illumination via a laser light source, a broadband light source, and combinations thereof. This illuminating may also be accomplished by passive illumination. In such an embodiment, a solar radiation source and/or ambient light source may be used.

In one embodiment, a first plurality of interacted photons may be passed through a filter selected from the group consisting of: a tunable filter, a fixed filter, a dielectric filter, and combinations thereof. In an embodiment comprising a tunable filter, this filter may comprise technology available from ChemImage Corporation, Pittsburgh, Pa. This technology is more fully described in the following U.S. Patents and patent applications: U.S. Pat. No. 6,992,809, filed on Jan. 31, 2006, entitled “Multi-Conjugate Liquid Crystal Tunable Filter,” U.S. Pat. No. 7,362,489, filed on Apr. 22, 2008, entitled “Multi-Conjugate Liquid Crystal Tunable Filter,” Ser. No. 13/066,428, filed on Apr. 14, 2011, entitled “Short wave infrared multi-conjugate liquid crystal tunable filter.” These patents and patent applications are hereby incorporated by reference in their entireties.

In one embodiment, a first plurality of interacted photons may be passed through a filter selected from the group consisting of: a liquid crystal tunable filter, a multi-conjugate tunable filter, an acousto-optical tunable filter, a Lyot liquid crystal tunable filter, an Evans split-element liquid crystal tunable filter, a Sole liquid crystal tunable filter, a ferroelectric liquid crystal tunable filter, a Fabry Perot liquid crystal tunable filter, and combinations thereof.

In one embodiment, a first plurality of interacted photons may be detected using a detector selected from the group consisting of: a CCD, an ICCD, a CMOS detector, an InSb detector, an InGaAs detector, a MCT detector, an intervac-intensified detector, a microbolometer, a PtSi detector, and combinations thereof. In one embodiment, this detector may comprise a focal plane array.

In one embodiment, this spatially accurate wavelength resolved image may be selected from the group consisting of: a spatially accurate wavelength resolved fluorescence image, a spatially accurate wavelength resolved Raman image, a spatially accurate wavelength resolved near infrared image, a spatially accurate wavelength resolved short wave infrared image, a spatially accurate wavelength resolved mid wave infrared image, a spatially accurate wavelength resolved long wave infrared image, and combinations thereof. In one embodiment, each pixel in said image is the spectrum of said sample at the corresponding location.

This image can be analyzed in step 850 to thereby identify said unknown substance. In one embodiment, said unknown substance may comprise at least one of: a biological substance, a chemical substance, an explosive substance, a toxic substance, a hazardous substance, and inert substance, and combinations thereof. Examples of explosive materials that may be detected using the system and method disclosed herein include, but are not limited to: explosives selected from the group consisting of: nitrocellulose, Ammonium nitrate (“AN”), nitroglycerin, 1,3,5-trinitroperhydro-1,3,5-triazine (“RDX”), 1,3,5,7-tetranitroperhydro-2,3,5,7-tetrazocine)(“HMX”) and 1,3,-Dinitrato-2,2-bis(nitratomethyl)propane (“PETN”), and combinations thereof. In one embodiment, said analyzing may further comprise comparing said image to at least one reference data set, each reference data set corresponding to a known substance.

In one embodiment, the method 800 may further comprise providing a reference database. This reference database may comprise at least one reference data set corresponding to a known substance. In one embodiment, this reference database may comprise a plurality of reference data sets, each reference data set corresponding to a known substance. In one embodiment, at least one such reference data set may comprise at least one of: a fluorescence data set, a Raman data set, a near infrared data set, a short wave infrared data set, a mid wave infrared data set, a long wave infrared data set, and combinations thereof.

In one embodiment, comparing said image to said reference data set may be accomplished by applying one or more chemometric techniques. This technique may be selected from the group consisting of: principle component analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, and combinations thereof.

In one embodiment, the method 800 may further provide for the application of at least one pseudo color to said spatially accurate wavelength resolved image. In such an embodiment, each such pseudo color may be associated with a known substance. The use of pseudo color addition is more fully described in U.S. Patent Application No. US 2011/0012916, filed on Apr. 20, 2010, entitled “System and method for component discrimination enhancement based on multispectral addition imaging,” which is hereby incorporated by reference in its entirety which is hereby incorporated by reference in its entirety.

In one embodiment, two or more modalities may be implemented to identify an unknown substance. In such an embodiment two or more data sets may be fused. In one embodiment, this fusion may be accomplished using Bayesian fusion. In another embodiment, this fusion may be accomplished using technology available from ChemImage Corporation, Pittsburgh, Pa. This technology is more fully described in the following pending U.S. patent applications: No. US2009/0163369, filed on Dec. 19, 2008 entitled Detection of Pathogenic Microorganisms Using Fused Sensor Data,” Ser. No. 13/081,992, filed on Apr. 7, 2011, entitled “Detection of Pathogenic Microorganisms Using Fused Sensor Raman, SWIR and LIBS Sensor Data,” No. US2009/0012723, filed on Aug. 22, 2008, entitled “Adaptive Method for Outlier Detection and Spectral Library Augmentation,” No. US2007/0192035, filed on Jun. 9, 2006, “Forensic Integrated Search Technology,” and No. US2008/0300826, filed on Jan. 22, 2008, entitled “Forensic Integrated Search Technology With Instrument Weight Factor Determination.” These applications are hereby incorporated by reference in their entireties.

In one embodiment, said unknown substance may comprise a mixture. In such an embodiment, the method 800 may further provide for analyzing said spatially accurate wavelength resolved image to thereby determine at least one of: constituents of a mixture, concentrations of constituents of a mixture, and combinations thereof.

In one embodiment, the method 800 may be automated using software. In one embodiment, the invention of the present disclosure may utilize machine readable program code which may contain executable program instructions. A processor may be configured to execute the machine readable program code so as to perform the methods of the present disclosure. In one embodiment, the program code may contain the ChemImage Xpert® software marketed by ChemImage Corporation of Pittsburgh, Pa. The ChemImage Xpert® software may be used to process image and/or spectroscopic data and information received from a system of the present disclosure to obtain various spectral plots and images, and to also carry out various multivariate image analysis methods discussed herein.

In one embodiment, the present disclosure provides for a storage medium containing machine readable program code, which, when executed by a processor, causes said processor to perform the following: generate at least one RGB image representative of said sample; assess said RGB image to thereby evaluate a first feature of said entities wherein said first feature is characteristic of said unknown substance; select at least one region of interest of said sample wherein said region of interest of said sample comprises at least one entity exhibiting said first feature; generate at least one spatially accurate wavelength resolved image of said region of interest wherein each pixel in said image is the spectrum of said sample at the corresponding location; and analyze said spatially accurate wavelength resolved image to thereby identify said unknown substance as comprising at least one of: a biological substance, a chemical substance, an explosive substance, a toxic substance, a hazardous substance, an inert substance, and combinations thereof.

In another embodiment, said machine readable program code, when executed by a processor to analyze said spatially accurate wavelength resolved image, may further cause said processor to: compare said spatially accurate wavelength resolved image to at least one reference data set wherein each said reference data set corresponds to a known substance.

In yet another embodiment, said machine readable program code, when executed by a process to analyze said spatially accurate wavelength resolved image and wherein said unknown substance comprises a mixture, may further cause said processor to: analyze said spatially accurate wavelength resolved image to thereby determine at least one of: constituents of a mixture, concentrations of constituents of a mixture, and combinations thereof.

The present disclosure also provides for a system, which may be configured to perform the methods disclosed herein. In one embodiment, this system may be configured so as to assess the occurrence of an unknown substance in a sample that comprises multiple entities. In one embodiment, this unknown substance may be selected from the group consisting of: a biological substance, a chemical substance, an explosive substance, a toxic substance, a hazardous substance, an inert substance, and combinations thereof.

In one embodiment, this system may comprise a reference database comprising a plurality of reference data sets. Each said reference data set may be associated with a known substance. The system may further comprise a first detector, configured to generate at least one RGB image representative of a sample. In one embodiment, this first detector may comprise a video capture device. In another embodiment, this first detector may comprise a CMOS ROB detector. The system may comprise a means for assessing this ROB image to thereby evaluate a first feature of said entities wherein said first feature is characteristic of said unknown substance. In one embodiment, this means may comprise displaying said ROB image for visual inspection by a user. Features such as size, shape and/or color may be assessed by such display. In another embodiment, this means may comprise comparing said RGB image to at least one reference data set in said reference database. This comparing may be automated via software and may implement a chemo metric technique.

The system may further comprise a means for selecting at least one region of interest of said sample. This region of interest may correspond to an area of said sample comprising an entity exhibiting said first feature. This region of interest may be selected upon visual inspection by a user or automated via software. This automation may comprise comparison to a reference data set by applying a chemometric technique.

In one embodiment, the system may further comprise a second detector configured so as to generate at least one spatially accurate wavelength resolved image of said region of interest. In one embodiment, this spatially accurate wavelength resolved image may comprise at least one of: a spatially accurate wavelength resolved fluorescence image, a spatially accurate wavelength resolved Raman image, a spatially accurate wavelength resolved near infrared image, a spatially accurate wavelength resolved short e infrared image, a spatially accurate wavelength resolved mid wave infrared image, a spatially accurate wavelength resolved long wave infrared image, and combinations thereof. In one embodiment, this spatially accurate wavelength resolved image may comprise a hyperspectral image.

In one embodiment, this second detector may comprise at least one of: a CCD, an ICCD, a CMOS detector, an InSb detector, an InGaAs detector, a MCT detector, an intervac-intensified detector, a microbolometer, a PtSi detector, and combinations thereof. In one embodiment, each pixel of said spatially accurate wavelength resolved image may be the spectrum of said sample at the corresponding location.

The system may further comprise a means for analyzing said spatially accurate wavelength resolved image to thereby identify said unknown substance. In one embodiment, this analyzing may comprise comparing said spatially accurate wavelength resolved image to at least one reference data set in a reference database. In one embodiment, at least one reference data set may comprise at least one of: a fluorescence data set, a near infrared data set, a short wave infrared data set, a mid wave infrared data set, a long wave infrared data set, a Raman data set, and combinations thereof. This comparison may be automated by applying a chemometric technique.

In one embodiment, the system may further comprise at least one illumination source. This illumination source may be configured so as to illuminate at least one of said sample and said region of interest to thereby generate at least one plurality of interacted photons. This plurality of interacted photons may be absorbed, reflected, scattered, and/or emitted by at least one of said sample and said region of interest. In one embodiment, this illumination source may be an active illumination source such as a laser illumination source or a broadband light source. In another embodiment, the system of the present disclosure may be configured so as to operate in conjunction with a passive illumination source. Such passive illumination source may comprise a solar illumination source or an ambient light source.

In one embodiment, the system may further comprise at least one filter which may be configured to filter at least one said plurality of interacted photons. This filter may comprise a tunable filter, a fixed filter, a dielectric filter, and combinations thereof. In one embodiment, the system may comprise at least one tunable filter selected from the group consisting of: a liquid crystal tunable filter, a multi-conjugate tunable filter, an acousto-optical tunable filter, a Lyot liquid crystal tunable filter, an Evans split-element liquid crystal tunable filter, a Sole liquid crystal tunable filter, a ferroelectric liquid crystal tunable filter, a Fabry Perot liquid crystal tunable filter, and combinations thereof.

In one embodiment, the system may further comprise a fiber array spectral translator (FAST) device. A FAST device may comprise a two-dimensional array of optical fibers drawn into a one-dimensional fiber stack so as to effectively convert a two-dimensional field of view into a curvilinear field of view, and wherein said two-dimensional array of optical fibers is configured to receive said photons and transfer said photons out of said fiber array spectral translator device and to at least one of: a spectrometer, a filter, a detector, and combinations thereof.

The FAST device can provide faster real-time analysis for rapid detection, classification, identification, and visualization of, for example, explosive materials, hazardous agents, biological warfare agents, chemical warfare agents, and pathogenic microorganisms, as well as non-threatening objects, elements, and compounds. FAST technology can acquire a few to thousands of full spectral range, spatially resolved spectra simultaneously. This may be done by focusing a spectroscopic image onto a two-dimensional array of optical fibers that are drawn into a one-dimensional distal array with, for example, serpentine ordering. The one-dimensional fiber stack may be coupled to an imaging spectrometer, a detector, a filter, and combinations thereof. Software may be used to extract the spectral/spatial information that is embedded in a single CCD image frame.

One of the fundamental advantages of this method over other spectroscopic methods is speed of analysis. A complete spectroscopic imaging data set can be acquired in the amount of time it takes to generate a single spectrum from a given material. FAST can be implemented with multiple detectors. Color-coded FAST spectroscopic images can be superimposed on other high-spatial resolution gray-scale images to provide significant insight into the morphology and chemistry of the sample.

The FAST system allows for massively parallel acquisition of full-spectral images. A FAST fiber bundle may feed optical information from is two-dimensional non-linear imaging end (which can be in any non-linear configuration, e.g., circular, square, rectangular, etc.) to its one-dimensional linear distal end. The distal end feeds the optical information into associated detector rows. The detector may be a CCD detector having a fixed number of rows with each row having a predetermined number of pixels. For example, in a 1024-width square detector, there will be 1024 pixels (related to, for example, 1024 spectral wavelengths) per each of the 1024 rows.

The construction of the FAST array requires knowledge of the position of each fiber at both the imaging end and the distal end of the array. Each fiber collects light from fixed position in the two-dimensional array (imaging end) and transmits this light onto a fixed position on the detector (through that fiber's distal end).

Each fiber may span more than one detector row, allowing higher resolution than one pixel per fiber in the reconstructed image. In fact, this super-resolution, combined with interpolation between fiber pixels (i.e., pixels in the detector associated with the respective fiber), achieves much higher spatial resolution than is otherwise possible. Thus, spatial calibration may involve not only the knowledge of fiber geometry (i.e., fiber correspondence) at the imaging end and the distal end, but also the knowledge of which detector rows are associated with a given fiber.

In one embodiment, a system of the present disclosure may comprise FAST technology available from ChemImage Corporation, Pittsburgh, Pa. This technology is more fully described in the following U.S. Patents, hereby incorporated by reference in their entireties: U.S. Pat. No. 7,764,371, filed on Feb. 15, 2007, entitled “System And Method For Super Resolution Of A Sample In A Fiber Array Spectral Translator System”; U.S. Pat. No. 7,440,096, filed on Mar. 3, 2006, entitled “Method And Apparatus For Compact Spectrometer For Fiber Array Spectral Translator”; U.S. Pat. No. 7,474,395, filed on Feb. 13, 2007, entitled “System And Method For Image Reconstruction In A Fiber Array Spectral Translator System”; and U.S. Pat. No. 7,480,033, filed on Feb. 9, 2006, entitled “System And Method For The Deposition, Detection And Identification Of Threat Agents Using A Fiber Array Spectral Translator”.

In an embodiment wherein the sample under analysis comprises a mixture, a system of the present disclosure may further comprise a means for analyzing said spatially accurate wavelength resolved image to thereby determine at least one of: constituents of a mixture, concentrations of constituents of a mixture, and combinations thereof.

While the disclosure has been described in detail in reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents

What is claimed is:

1. A method of assessing the occurrence of an unknown substance in a sample that comprises multiple entities, the method comprising:
generating at least one RGB image representative of said sample;
assessing said RGB image to thereby evaluate a first feature of said entities wherein said first feature is characteristic of said unknown substance;
selecting at least one region of interest of said sample wherein said region of interest of said sample comprises at least one entity exhibiting said first feature;
generating at least one spatially accurate wavelength resolved image of said region of interest wherein each pixel in said image is the spectrum of said sample at the corresponding location; and
analyzing said spatially accurate wavelength resolved image to thereby identify said unknown substance.

2. The method of claim 1 wherein said analyzing further comprises comparing said spatially accurate wavelength resolved image to at least one reference data set, each said reference data set corresponding to a known substance.

3. The method of claim 2 wherein said reference data set comprises at least one of: a fluorescence data set, a Raman data set, a near infrared data set, a short wave infrared data set, a mid wave infrared data set, a long wave infrared data set, and combinations thereof.

4. The method of claim 2 wherein said comparing is achieved by applying at least one chemometric technique.

5. The method of claim 4 wherein said chemometric technique is selected from the group consisting of: principle component analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, and combinations thereof.

6. The method of claim 1 wherein said spatially accurate wavelength resolved image comprises an image selected from the group consisting of: a spatially accurate wavelength resolved fluorescence image, a spatially accurate wavelength resolved Raman image, a spatially accurate wavelength resolved near infrared image, a spatially accurate wavelength resolved short wave infrared image, a spatially accurate wavelength resolved mid wave infrared image, a spatially accurate wavelength resolved long wave infrared image, and combinations thereof.

7. The method of claim 1 wherein said spatially accurate wavelength resolved image comprises a hyperspectral image.

8. The method of claim 1 wherein said generating of said spatially accurate wavelength resolved image further comprises:
collecting a first plurality of interacted photons representative of said region of interest, wherein said first plurality of interacted photons are selected from the group consisting of:
photons absorbed by said region of interest, photons reflected by said region of interest, photons emitted by said region of interest, photons scattered by said region of interest, and combinations thereof;
passing said first plurality of interacted photons through a filter; and
detecting said first plurality of interacted photons to thereby generate said spatially accurate wavelength resolved image.

9. The method of claim 8 wherein said first plurality of interacted photons are generated by illuminating said region of interest.

10. The method of claim 9 wherein said illuminating comprises at least one of: passive illumination, active illumination and combinations thereof.

11. The method of claim 8 wherein said filter comprises a filter selected from the group consisting of: a tunable filter, a fixed filter, a dielectric filter, and combinations thereof.

12. The method of claim 11 wherein said tunable filter is selected from the group consisting of:
a liquid crystal tunable filter, a multi-conjugate tunable filter, an acousto-optical tunable filter, a Lyot liquid crystal tunable filter, an Evans split-element liquid crystal tunable filter, a Sole liquid crystal tunable filter, a ferroelectric liquid crystal tunable filter, a Fabry Perot liquid crystal tunable filter, and combinations thereof.

13. The method of claim 8 wherein said detecting is achieved using a detector selected from the group consisting of: a CCD, an ICCD, a CMOS detector, an InSb detector, an InGaAs detector, a MCT detector, an intervac-intensified detector, a microbolometer, a PtSi detector, and combinations thereof.

14. The method of claim 8 wherein said detecting is achieved using a focal plane array.

15. The method of claim 1 further comprising applying at least one pseudo color to said spatially accurate wavelength resolved image, wherein each said pseudo color is associated with a known substance.

16. The method of claim 1 wherein said unknown substance comprises at least one of: a biological substance, a chemical substance, an explosive substance, a toxic substance, a hazardous substance, an inert substance, and combinations thereof.

17. The method of claim 1 wherein said assessing of said RGB image further comprises assessing at least one morphological feature, wherein said morphological feature is selected from the group consisting of: shape, color, size, and combinations thereof.

18. The method of claim 1, wherein said unknown substance comprises a mixture, and further comprising:
analyzing said spatially accurate wavelength resolved image to thereby determine at least one of: constituents of a mixture, concentrations of constituents of a mixture, and combinations thereof.

19. A system for assessing the occurrence of an unknown substance in a sample that comprises multiple entities, the system comprising:
a reference database comprising a plurality of reference data sets, wherein each said reference data set is associated with a known substance;
a first detector configured so as to generate at least one RGB image representative of said sample:
a means for assessing said RGB image to thereby evaluate a first feature of said entities wherein said first feature is characteristic of said unknown substance;
a means for selecting at least one region of interest of said sample wherein said region of interest of said sample comprises at least one entity exhibiting said first feature;
a second detector configured so as to generate at least one spatially accurate wavelength resolved image of said region of interest wherein each pixel in said image is the spectrum of said sample at the corresponding location; and
a means for analyzing said spatially accurate wavelength resolved image to thereby identify said unknown substance, wherein said analyzing comprises comparing said spatially accurate wavelength resolved image to at least one reference data set in said reference database.

20. The system of claim 19 wherein said means for analyzing is configured so as to identify said unknown substance as comprising at least one of: a biological substance, a chemical substance, an explosive substance, a toxic substance, a hazardous substance, an inert substance, and combinations thereof.

21. The system of claim 19 further comprising at least one illumination source, wherein said illumination source is configured so as to illuminate at least one of said sample and said region of interest to thereby generate at least one plurality of interacted photons.

22. The system of claim 21 further comprising at least one filter configured so as to filter said plurality of interacted photons.

23. The system of claim 22 wherein said filter comprises a filter selected from the group consisting of: a tunable filter, a fixed filter, a dielectric filter, and combinations thereof.

24. The system of claim 23 wherein said tunable filter is selected from the group consisting of: a liquid crystal tunable filter, a multi-conjugate tunable filter, an acousto-optical tunable filter, a Lyot liquid crystal tunable filter, an Evans split-element liquid crystal tunable filter, a Solc liquid crystal tunable filter, a ferroelectric liquid crystal tunable filter, a Fabry Perot liquid crystal tunable filter, and combinations thereof.

25. The system of claim 19 further comprising a fiber array spectral translator device wherein said fiber array spectral translator device comprises: a two-dimensional array of optical fibers drawn into a one-dimensional fiber stack so as to effectively convert a two-dimensional field of view into a curvilinear field of view, and wherein said two-dimensional array of optical fibers is configured to receive said photons and transfer said photons out of said fiber array spectral translator device and to at least one of: a spectrometer, a filter, a detector, and combinations thereof.

26. The system of claim 19 wherein said first detector comprises at least one of: a video capture device, a CMOS RGB detector, and combinations thereof.

27. The system of claim 19 wherein said second detector comprises at least one of: a CCD, an ICCD, a CMOS detector, an InSb detector, an InGaAs detector, a MCT detector, an intervac-intensified detector, a microbolometer, a PtSi detector, and combinations thereof.

28. The system of claim 19 wherein said spatially accurate wavelength image comprises a hyperspectral image.

29. The system of claim 19 wherein said at least one reference data sets comprises at least one of: a fluorescence data set, a near infrared data set, a short wave infrared data set, a mid wave infrared data set, a long wave infrared data set, a Raman data set, and combinations thereof.

30. The system of claim 19 wherein said spatially accurate wavelength resolved image comprises at least one of: a spatially accurate wavelength resolved fluorescence image, a spatially accurate wavelength resolved Raman image, a spatially accurate wavelength resolved near infrared image, a spatially accurate wavelength resolved short wave infrared image, a spatially accurate wavelength resolved mid wave infrared image, a spatially accurate wavelength resolved long wave infrared image, and combinations thereof.

31. The system of claim 19 wherein said unknown substance comprises a mixture, and further comprising a means for analyzing said spatially accurate wavelength resolved image to thereby determine at least one of: constituents of a mixture, concentrations of constituents of a mixture, and combinations thereof.

32. A storage medium containing machine readable program code, which, when executed by a processor, causes said processor to perform the following:
generate at least one RGB image representative of said sample;
assess said RGB image to thereby evaluate a first feature of said entities wherein said first feature is characteristic of said unknown substance;
select at least one region of interest of said sample wherein said region of interest of said sample comprises at least one entity exhibiting said first feature;
generate at least one spatially accurate wavelength resolved image of said region of interest wherein each pixel in said image is the spectrum of said sample at the corresponding location; and
analyze said spatially accurate wavelength resolved image to thereby identify said unknown substance as comprising at least one of: a biological substance, a chemical substance, an explosive substance, a toxic substance, a hazardous substance, an inert substance, and combinations thereof.

33. The storage medium of claim 32 wherein said machine readable program code, when executed by a processor to analyze said spatially accurate wavelength resolved image, further causes said processor to:
compare said spatially accurate wavelength resolved image to at least one reference data set wherein each said reference data set corresponds to a known substance.

34. The storage medium of claim 32 wherein said machine readable program code, when executed by a processor to analyze said spatially accurate wavelength resolved image and wherein said unknown substance comprises a mixture, further causes said processor to:
analyze said spatially accurate wavelength resolved image to thereby determine at least one of: constituents of a mixture, concentrations of constituents of a mixture, and combinations thereof.
